(19) United States
(12) Patent Application Publication
(10) Pub. No.: US 2008/0239763 A1
(43) Pub. Date: Oct. 2, 2008

(54) METHOD AND APPARATUS FOR QUASI-RESONANT CURRENT MODE POWER CONVERSION

(76) Inventor: Norman McCollough, (US)

Correspondence Address: PATENT GROUP;C/O DLA PIPER US LLP, 203 N. LASALLE ST., SUITE 1900, CHICAGO, IL, 60601, US

(21) Appl. No.: 11/733,260

(22) Filed: Apr. 10, 2007

Related U.S. Application Data
(60) Provisional application No. 60/908,501, filed on Mar. 28, 2007.

(51) Int. Cl. H02M 3/335

(52) U.S. Cl. 363/21.03

(57) ABSTRACT

A method and apparatus to magnetically couple AC power from the high voltage electric utility power line current induced magnetic field over a wide voltage and current range to provide a low voltage, low current DC power supply useful in powering other remotely located or limited accessibility circuitry requiring low voltage DC power to operate.

### CLAIM OF PRIORITY

This application claims priority from U.S. Provisional Patent No. 60/908,501, filed Mar. 28, 2007.

### BACKGROUND OF THE INVENTION

1. Field of Invention

This invention finds us in the field of electrical current distribution and in particular powering of battery operated circuits used in devices for monitoring and regulating electrical current.

2. Background

In modern low power direct current electronic circuits such as rf repeaters, telephony apparatus, cable tv, internet devices, RFID sensor based monitoring devices; or other similar type devices; powering those circuits deployed in field or remote areas from batteries is not a viable option due to the amount of direct current (“DC”) voltage and current required to power them for the desired deployment length of time. This is especially true of devices intended to perform specific functions of monitoring, wireless relay, or communications functions in remote areas where changing a battery periodically is expensive and the lack of access is problematic.

One presently used option is to power such devices by having the electric utility set an alternating current (“AC”) transformer to “step down” the electric utility primary high voltage to a nominal 120 v AC voltage and powering devices using a standard 120 v AC to low voltage DC power supply. One disadvantage of this solution is that it is often expensive to install the transformer and may additionally result in the need for power restoration means after a loss of power due to transformer secondary fuse opening, secondary voltage fault, lightning, or other common reasons for power line voltage loss on electric utility secondary systems.

### SUMMARY OF THE INVENTION

A method and apparatus for providing a low cost solution to powering remote or higher DC power requirement devices in problematic areas that may normally preclude setting a utility AC power transformer. The inventive method uses electric utility power line current magnetic fields, as determined by the loads placed on the lines, and converts the resulting magnetic energy into low voltage direct current by using an inductor to couple the AC magnetic field energy into an AC to DC rectifier and voltage doubler circuit. The associated inventive apparatus provides a DC power source suitable for powering active tag RFID based sensor devices, low power RF repeaters for broadband over power line, CATV repeaters, telephony apparatus, remote environmental, atmospheric, chemical, homeland security, or other sensor based monitoring devices where the devices on the power line require a low voltage DC source for operation.

### BRIEF DESCRIPTION OF THE DRAWING

Specific embodiments of the invention have been chosen for purposes of illustration and description, and are shown in the accompanying drawing, forming part of the specification, wherein:

FIG. 1 is schematic diagram of the power converter circuit apparatus according to the invention.

### DESCRIPTION OF PREFERRED EMBODIMENTS

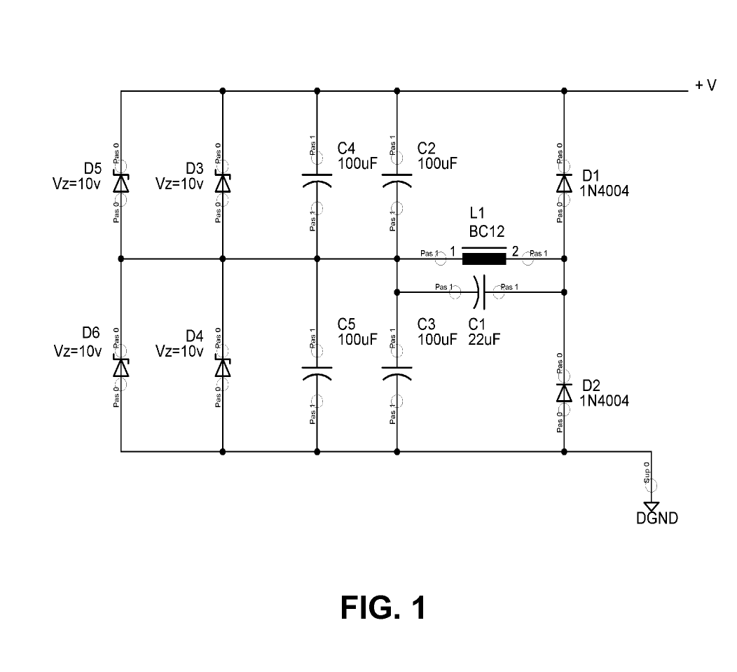

Now referring to FIG. 1, to those ordinarily skilled in the art of power conversion, it will be noted that the elements of coil L1, capacitor C1 and the resistance of coil L1 would form a tank or resonant circuit. The circuit elements of coil L1 and capacitor C1 are chosen to resonate at the nominal power frequency of 60 Hz. The circuit elements of diode D1, capacitor C2, capacitor C4 and diode D2, capacitor C3, capacitor C5 are used as a voltage doubler circuit.

The core construction of coil L1 could be one of many types such as a U1 construction, E1 construction, EE construction, toroidal construction, or split core toroidal construction. To those ordinarily skilled in the art of transformer design, it would be noted that the E1, U1, EE, toroidal or split core toroidal constructions refer to the shape of the transformer core, only. Further, coil L1's core must saturate at sufficiently low enough 60 Hz AC current to allow a maximum change of voltage with rate of change of 60 Hz AC current. In the preferred embodiment, a very high permeability split core toroid ferrite core is used to allow installation of the power converter apparatus without cutting the electric utility medium voltage conductor. This is highly advantageous since cutting and splicing an electric utility power line conductor introduces a source of potential failure of the conductor.

Diodes D1 and D2 are of the low forward drop Schottky variety. In the preferred embodiment, as the cut-in voltage of diodes D1 and D2 are reached respectively, the combined diode D1, capacitor C2, capacitor C4 and diode D2, capacitor C3, capacitor C5 respectively are active in the circuits. The nonlinear operation of diodes D1 and D2 effectively provide the parallel circuit path to place capacitors C2, C4 and C3, C5 alternatively in series with capacitor C1 thus spoiling the Q or resonance frequency of the resonant tank circuit formed by coil L1 and capacitor C1. It is the change in loading and resonance or “Quasi” resonant tank circuit operating in the time before the forward cut-in voltage of diodes D1 and D2 that allow power coupling from the AC magnetic field induced in coil L1 to be used. Zener diodes D3, D5 and D4, D6 are used to protect the capacitors C2, C4 and C3, C5 respectively from excessive voltage and to provide regulation of output voltage +V. As will be apparent to those ordinarily skilled in the art of power supply design, the output voltage +V is determined by the zener diodes D3, D4, and D5, D6 and may be chosen by the zener breakdown voltage to allow different DC voltages as required by a specific application. It is further noted that other frequencies of AC current may be used with changes in the tank circuit formed by coil L1, and capacitor C1.

It should be noted that the coupled split core inductor L1 also be considered a special form of a current transformer. In the preferred embodiment, the split core coupled inductor current transformer L1 primary winding is formed from the single conductor of the electric utility high voltage line passing thru the center of the split core coupled inductor L1. In this case, split core coupled inductor L1 would be considered to have a 1 turn primary transformer winding as only one conductor passes thru the center of the split core coupled inductor. The turns on the core of coupled inductor coil L1 form the secondary transformer winding of the current transformer. In the preferred embodiment, the current flowing in the electric utility power line conductor may range from 2 amperes to hundreds of amperes. Thus the primary winding ampere-turns of the coupled split core inductor L1 current transformer vary directly as the electric utility line current. The coupled split core inductor L1 is further constructed to operate during overload conditions of the electric power line during a fault condition where thousands of amperes may flow in the electric utility conductor for some period of time with out damaging the embodiment of the power converter circuit.

The construction of the coupled split core of coupled inductor L1 is such that operation during both low and very high primary current flow, the core of inductor L1's magnetic field (B) versus L1's inductance (H) characteristics serve to limit the secondary voltage produced by L1 due to saturating out the core of the coupled split core inductor L1. The magnetic material for coupled split core inductor L1 is a ferrite material having a very high magnetic permeability. The permeability is defined as the ratio of magnetic flux density to magnetic field strength. To those ordinarily skilled in the art of transformer design, it would be noted that normally core saturation is an undesirable operation of a transformer. However; in the preferred embodiment of the invention, since the coupled split core inductor L1 operates in a quasi-resonant mode, the magnetic field energy coupled from the power line is limited so as to limit the voltage produced by the coupled split core toroid inductor L1 secondary winding regardless of the magnitude of the primary current. The coupled split core inductor L1 operates in the saturation mode exclusively for all currents above 2 amperes within the electric utility power line. Also noted, capacitor C1 is of a non-polarized type capacitor since in the preferred embodiment coil L1 produces an AC voltage. Additional voltage limiting across capacitor C1 may also be incorporated in the circuit to allow lower voltage capacitors to be used with out over-voltage on capacitor C1 during higher primary current levels in split core coupled inductor L1.

The related method of use of the described apparatus utilizes the electric utility power line current magnetic fields, as determined by the loads placed on the lines, and converts the resulting magnetic energy into low voltage direct current by using an inductor to couple the AC magnetic field energy into an AC to DC rectifier and voltage doubler circuit. Typical loads for the electric utility power lines range from 2 to many hundreds of amperes. It is the radiated AC magnetic field energy that is received by the previously described coupled inductor and capacitor so as to resonate at the low frequency of the electric utility supply and then converted to a DC voltage. Typical resonance frequencies are 30 Hz, 50 Hz, 60 Hz, or 400 Hz. The low voltage direct current powers devices such as active tag RFID sensors, low power RF repeaters for broadband over power line, CATV repeaters, telephony apparatus, and remote environmental, atmospheric, chemical, and homeland security monitoring devices.

In addition to the structures, sequences, methods and uses immediately described above, it will be apparent to those skilled in the art that other modifications and variations can be made to the method of the instant invention without diverging from the scope, spirit, or teaching of the invention. Therefore, it is the intention of the inventors that the description of instant invention should be considered illustrative and the invention is to be limited only as specified in the claims and equivalents thereto.

I claim:

1. A power converter formed by a low frequency quasi resonant circuit comprised of a coupled inductor and a capacitor

2. The power converter of claim 1 wherein said coupled inductor is formed from a material selected from the group consisting of a toroidal ferrite, a U1 ferrite, an EE ferrite, and an E1 ferrite.

3. The power converter of claim 1 comprising a split core toroidal ferrite conductor adapted to allow installation on an existing electric utility power line medium voltage conductor without cutting the conductor; whereby the one turn primary of a coupled inductor being is formed by the medium voltage power line.

4. The power converter of claim 3 wherein the split core coupled ferrite inductor is constructed of a material to provide a minimum initial permeability of 7500 permeability.

5. The split core coupled ferrite inductor of claim 3 wherein the core is formed from Manganese and Zinc ferrite.

6. The coupled split core ferrite inductor of claim 3 where the coupled split core inductor operates in a saturated core mode for any current above 2 amperes flowing in a one turn primary.

7. The power converter of claim 1 further comprising a voltage doubler circuit that is incorporated to allow primary power line low current circuit operation.

8. The method of using a ferrite core inductor to receive radiated low frequency magnetic energy from an electric utility conductor line varying load current induced alternating current magnetic field, the method comprising converting the radiated alternating magnetic field energy to an alternating current voltage, storing the alternating current voltage in a capacitor and converting the stored alternating current electrical voltage to a low voltage direct current.

9. The method of claim 8 further comprising the steps of setting a resonant frequency of a tank circuit formed by the combinations of the capacitor C1 and a coil L1 to resonate with the alternating current magnetic field of the electric utility medium voltage current carrying conductor.

10. The method of claim 9 wherein the resonance frequency is selected from the group consisting of 30 Hz, 50 Hz, 60 Hz, or 400 Hz.

11. The method of claim 8 where the low voltage direct current powers devices selected from the group comprising active tag RFID sensors, low power RF repeaters for broadband over power line, CATV repeaters, telephony apparatus, and remote environmental, atmospheric, chemical, and homeland security monitoring devices.
